(19) United States
(12) Patent Application Publication
(10) Pub. No.: US 2007/0268972 A1
(43) Pub. Date: Nov. 22, 2007

(54) Method and apparatus for transmitting/receiving uncompressed AV data

(75) Inventor: Ki-bo Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONIS CO., LTD., Suwon-si (KR)

(21) Appl. No.: 11/727,066

(22) Filed: Mar. 23, 2007

Related U.S. Application Data
(60) Provisional application No. 60/800,430, filed on May 16, 2006.
(60) Provisional application No. 60/811,796, filed on Jun. 8, 2006.

(30) Foreign Application Priority Data
Sep. 5, 2006 (KR) 10-2006-0085286

(51) Int. Cl. H04N 7/64

(52) U.S. Cl. 375/240.27; 375/E07.279

(57) ABSTRACT

Provided is a method of differentially coding uncompressed AV data. A method for transmitting uncompressed AV data according to an embodiment of the invention includes grouping bits of the uncompressed AV data into a plurality of groups according to significance of the bits; determining a code rate for every group; applying error correction coding to each group at the determined code rate; and transmitting the groups to which the error correction coding has been applied.

### CROSS REFERENCE TO RELATED APPLICATIONS

This application and claims priority from Korean Patent Application No. 10-2006-0085286 filed on Sep. 5, 2006, in the Korean Intellectual Property Office, and U.S. Provisional Patent Application Nos. 60/800,430 filed on May 16, 2006 and 60/811,796 filed on Jun. 8, 2006 in the United States Patent and Trademark Office, the disclosures of which are entirely incorporated herein by reference.

### BACKGROUND OF THE INVENTION

1. Field of the Invention

Apparatuses and methods consistent with the present invention relate to a wireless communication technique, and more particularly, to differentially coding uncompressed audio/video data.

2. Description of the Related Art

With the advancements made in wireless network techniques, the demand for transmitting mass multimedia data has been increasing, along with the demand for an effective transmission method in a wireless network environment. In addition, the necessity for wireless transmission of a high-quality video, such as a digital video disk (DVD) video, a high definition television (HDTV) video, among various home devices is also increasing.

Currently, a task group of IEEE 802.15.3c is considering a technical standard for transmitting mass data over a wireless home network. This standard, called a millimeter wave (mmWave), uses an electric wave having a physical wavelength of several millimeters to transmit mass data (that is, an electric wave having a frequency of 30 GHz to 300 GHz). In the related art, this frequency band is an unlicensed band and has seen limited use for, for example, communication carriers, radio astronomy, or vehicle anticollision.

FIG. 1 is a diagram illustrating a comparison between the frequency band of the IEEE 802.11 standards and the frequency band of the mmWave. In the IEEE 802.11b standard or the IEEE 802.11g standard, a carrier frequency is 2.4 GHz, and a channel bandwidth is about 20 MHz. Further, in the IEEE 802.11a standard or the IEEE 802.11 n standard, a carrier frequency is 5 GHz, and a channel bandwidth is about 20 MHz. In contrast, in the mmWave, a carrier frequency of 60 GHz is used, and a channel bandwidth is in the range of about 0.5 to 2.5 GHz. Accordingly, it can be seen that the mmWave has a considerably higher carrier frequency and a considerably larger channel bandwidth than the existing IEEE 802.11 standard. As such, if a high-frequency signal having a wavelength in millimeters (millimeter wave) is used, a high transmission rate of several Gbps can be obtained, and the size of an antenna can be set to be smaller than 1.5 mm. Therefore, a single chip including the antenna can be implemented. In addition, since an attenuation ratio is very high in the air, the interference between apparatuses can be reduced.

In recent years, a technique for transmitting uncompressed audio or video data (AV) between wireless apparatuses using the millimeter wave having a large bandwidth has been studied. Compressed AV data is compressed with a partial loss through processes, such as motion compensation, discrete cosine transform (DCT) conversion, quantization, and variable length coding, such that portions of the data less sensitive to the sense of sight or the sense of hearing of human beings are eliminated. In contrast, uncompressed A/V data includes digital values (for example, R, G, and B components) representing pixel components.

Therefore, there is no significant difference between bits included in the compressed AV data, but there is a notable difference between bits included in the uncompressed AV data. For example, as shown in FIG. 2, in case of an 8-bit image, one pixel component is represented by 8 bits. Among the 8 bits, a bit representing the highest order (a bit at the highest level) is the most significant bit (MSB), and a bit representing the lowest order (a bit at the lowest level) is the least significant bit (LSB). That is, in 1-byte data composed of 8 bits, the bits have different significances in restoring a video signal or an audio signal. When an error occurs in a bit having high significance, it is possible to detect the error easier than when the error occurs in a bit having low significance. Therefore, it is necessary to protect bit data having high significance such that no error occurs in the bit data during wireless transmission, as compared to bit data having low significance. However, a related art transmission method of correcting errors of all bits to be transmitted at the same code rate has been used in the IEEE 802.11 standards.

FIG. 3 is a diagram illustrating the structure of a physical protocol data (PPDU) of the IEEE 802.11a standard. PPDU 30 includes a preamble, a signal field, and a data field. The preamble is a signal used for synchronizing a physical layer (PHY layer) and estimating a channel, and includes a plurality of short training signals and a plurality of long training signals. The signal field includes a RATE field indicating a transmission rate and a LENGTH field indicating the length of the PPDU. In general, the signal field is coded by one symbol. The data field is composed of PSDU, a tail bit, and a pad bit, and data to be transmitted actually is included in PSDU.

Data recorded on PSDU is composed of codes coded by a convolution encoder. There is no difference in significance between the codes, and the codes have been coded by the same error correction coding. Therefore, the codes have the same error correcting capability.

The related art method is effective for transmitting of general data. However, when there is a notable difference between data, a better error correction coding should be performed on bits having higher significance to reduce the probability that an error occurs in the bits.

The transmitter performs an error correction coding process on data in order to prevent occurrence of an error. Even when an error occurs in the error correction coded data, the error correction coded data having the error can be restored in a predetermined range in which the error can be corrected. There are various error correction coding processes, and the error correction coding processes have different capabilities to correct errors according to error correction coding algorithms. The performance of the error correction coding algorithms depends on a code rate.

In general, as the code rate becomes higher, the transmission efficiency of data becomes higher, but the capability to correct errors is lowered. In contrast, as the code rate becomes lower, the transmission efficiency of data becomes lower, but the capability to correct errors is raised. However, as described above, in the uncompressed AV data, there is difference in significance between bits constituting an uncompressed AV data, unlike the compressed AV data. Therefore, it is necessary to protect high-level bits having high significance such that no error occurs in the high-level bits during transmission.

In general, the following methods are used to ensure stable wireless data transmission: a method of using error correction coding to restore data, and a method of retransmitting data having an error from a transmitter to a receiver. By contrast, the present invention provides a method of differentially performing error correction coding for transmitting uncompressed AV data according to significance of bits constituting the uncompressed AV data.

### SUMMARY OF THE INVENTION

The present invention provides a method and apparatus for effectively performing error correction coding to ensure stable transmission of the uncompressed AV data.

The present invention also provides a detailed packet structure of retransmitted data.

The present invention is not limited to those mentioned above, and other aspects of the present invention will be apparently understood by those skilled in the art through the following description.

According to an aspect of the present invention, there is provided a method of transmitting uncompressed AV data, the method including grouping bits of uncompressed AV data into a plurality of groups according to significance of the bits; determining a code rate for every group; applying error correction coding to each group at the determined code rate; and transmitting the groups to which the error correction coding has been applied.

According to another aspect of the present invention, there is provided a method of receiving uncompressed AV data, the method including receiving the uncompressed AV data to which error correction coding has been applied to every group at a different coding rate; determining a code rate corresponding to each group; applying the error correction decoding to each group at the determined code rate; and restoring the uncompressed AV data by assembling the groups to which the error correction decoding has been applied.

According to still another aspect of the present invention, there is provided an apparatus for transmitting uncompressed AV data, the apparatus including a unit grouping bits of the uncompressed AV data into a plurality of groups according to significance of the bits; a unit determining a code rate for every group; a unit applying error correction coding to each group at the determined code rate; and a unit transmitting the groups to which the error correction coding has been applied.

According to yet another aspect of the present invention, there is provided an apparatus for receiving uncompressed AV data, the apparatus including a unit receiving the uncompressed AV data to which error correction coding has been applied to every group at a different coding rate; a unit determining a code rate corresponding to each group; a unit applying error correction decoding to each group at the determined code rate; and a unit restoring uncompressed AV data by assembling the groups to which the error correction decoding has been applied.

### BRIEF DESCRIPTION OF THE DRAWINGS

The above and other aspects of the present invention will become more apparent by describing in detail preferred embodiments thereof with reference to the attached drawings, in which:

FIG. 1 is a diagram illustrating the comparison between the frequency band of the IEEE 802.11 standard and the frequency band of an mmWave;

FIG. 2 is a diagram illustrating one pixel component having a plurality of bit levels;

FIG. 3 is a diagram illustrating the structure of a PPDU of the IEEE 802.11a standard;

FIG. 4 is a diagram illustrating an error correction coding method according to a related art;

FIG. 5 is a diagram illustrating an error correction coding method according to an exemplary embodiment of the invention;

FIG. 6 is a block diagram illustrating the structure of a transmitting apparatus for transmitting uncompressed AV data according to an exemplary embodiment of the invention;

FIG. 7 is a block diagram illustrating the detailed structure of a channel coding unit;

FIG. 8 is a block diagram illustrating an example of the structure of a convolution decoding unit having a code rate of 1/3;

FIG. 9 is a diagram illustrating an example of a puncturing process;

FIG. 10 is a diagram illustrating the structure of a transmission packet according to an exemplary embodiment of the invention;

FIG. 11 is a diagram illustrating the structure of a PHY header according to an exemplary embodiment of the invention;

FIG. 12 is a diagram illustrating the structure of a receiving apparatus for receiving uncompressed AV data according to an exemplary embodiment of the invention; and

FIG. 13 is a block diagram illustrating the structure of a channel decoding unit in more detail.

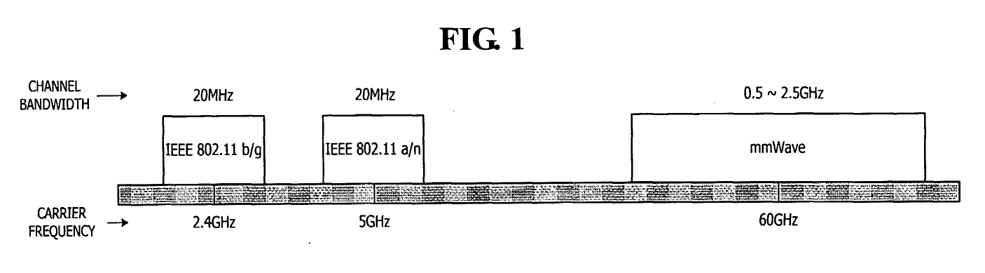

### DESCRIPTION OF THE EXEMPLARY EMBODIMENTS

Aspects of the present invention may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

Hereinafter, the exemplary embodiments of the present invention will now be described more fully with reference to the accompanying drawings.

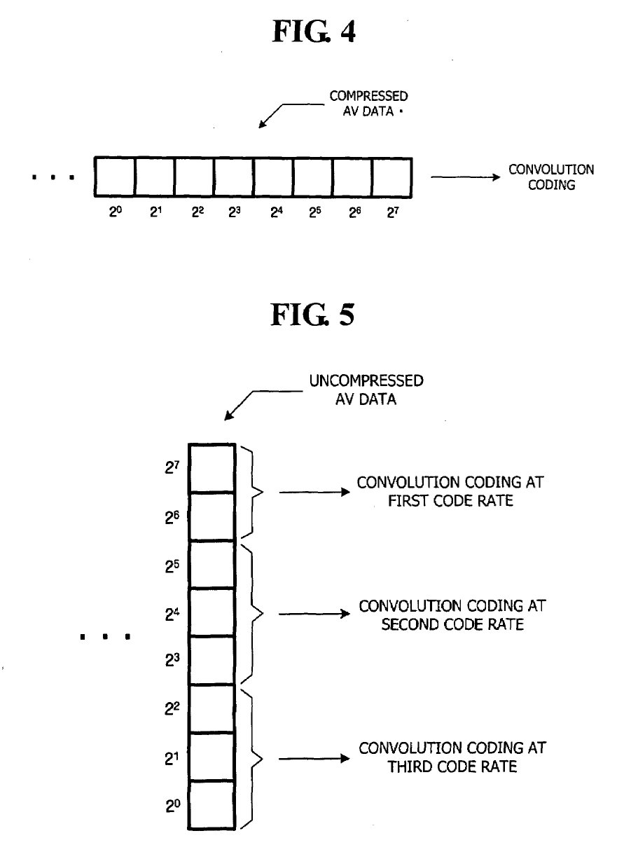

FIG. 4 is a view illustrating an error correction coding method according to a related art, and FIG. 5 is a view illustrating an error correction coding method according to an exemplary embodiment of the invention.

Compressed AV data is generated through processes for improving a compression rate, such as quantization and entropy coding, and thus there is no difference in significance between bits constituting each pixel that is included in the compressed AV data. Therefore, as shown in FIG. 4, in the related art, error correction coding is generally performed on the compressed AV data at a fixed code rate. Even when error correction coding using a variable code rate is applied to the compressed AV data, this application is based on an external environment, such as a communication environment, rather than the significance of each data bit.

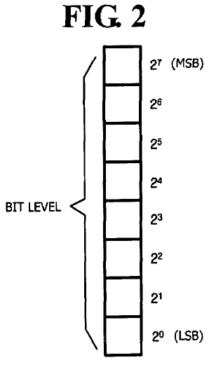

However, as described with reference to FIG. 2, in the compressed AV data, bits at different bit levels have different significances. Therefore, as shown in FIG. 5, it is preferable that a plurality of bits be classified into some groups according to bit levels and error correction coding be performed on the classified groups at different code rates. In this case, a lower code rate is applied to bits belonging to a group having relatively higher significance. Therefore, in this exemplary embodiment of the invention, different code rates are applied according to the significance of data to improve the transmission efficiency of uncompressed AV data.

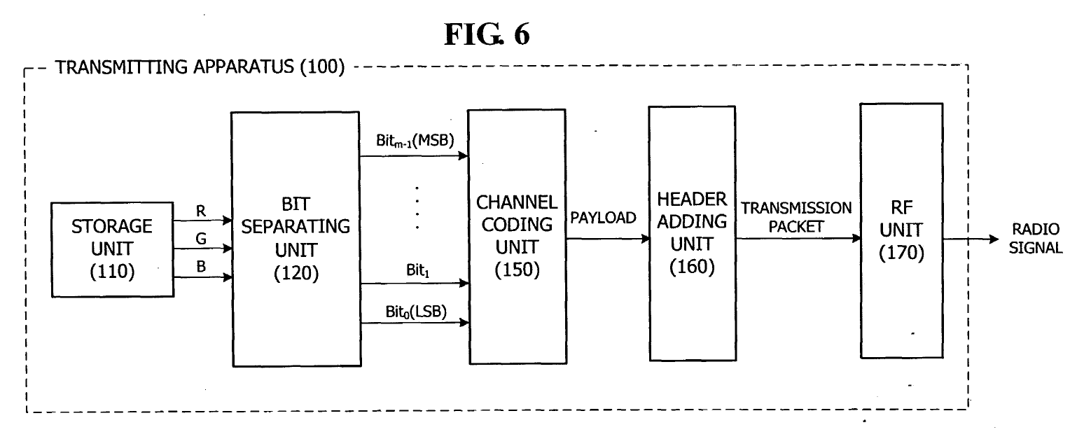

FIG. 6 is a block diagram illustrating the structure of a transmitting apparatus 100 for transmitting uncompressed AV data according to an exemplary embodiment of the invention. The transmitting apparatus 100 includes a storage unit 110, a bit separating unit 120, a channel coding unit 150, a header adding unit 160, and a radio frequency (RF) unit 170.

The storage unit 110 stores uncompressed AV data. When the AV data is video data, sub-pixel values of each pixel are stored in the storage unit 110. The sub-pixel values to be stored in the storage unit 110 may vary according to a color space used (for example, an RGB color space and a YCbCr color space). In this exemplary embodiment of the invention, each pixel includes three sub-pixels, that is, R, G, and B sub-pixels, corresponding to the RGB color space. When the video data is a gray-scale image, only one sub-pixel component exists. Therefore, one pixel may be composed of one sub-pixel, or it may be composed of two or four sub-pixels.

The bit separating unit 120 separates the sub-pixel values supplied from the storage unit 110 from a high order (high level) bit to a low order (low level) bit. For example, in case of an 8-bit video signal, orders from 2⁰ to 2⁷ exist, and thus the 8-bit video signal may be separated into 8 bits. In FIG. 6, “m” indicates the number of bits of a pixel, and “Bitₘ₋₁” indicates the bit of an order m-1. The bit separating process is independently performed on each sub-pixel.

The channel coding unit 150 performs error correction coding on the separated bits at a predetermined code rate to generate a payload.

The error correction coding includes block coding and convolution coding. In the block coding (for example, Reed-Solomon coding), data is coded or decoded in the unit of blocks. In the convolution coding, a memory having a predetermined size is used to compare previous data with current data, thereby performing coding. Basically, the block coding is effective for burst error correction, and the convolution coding is effective for random error correction.

Generally, the error correction coding process converts a k-bit input into an n-bit codeword. In this case, the code rate is represented by “k/n”. As the code rate becomes lower, the input is converted to a codeword composed of a larger number of bits, which results in an increase in the probability of the error being corrected.

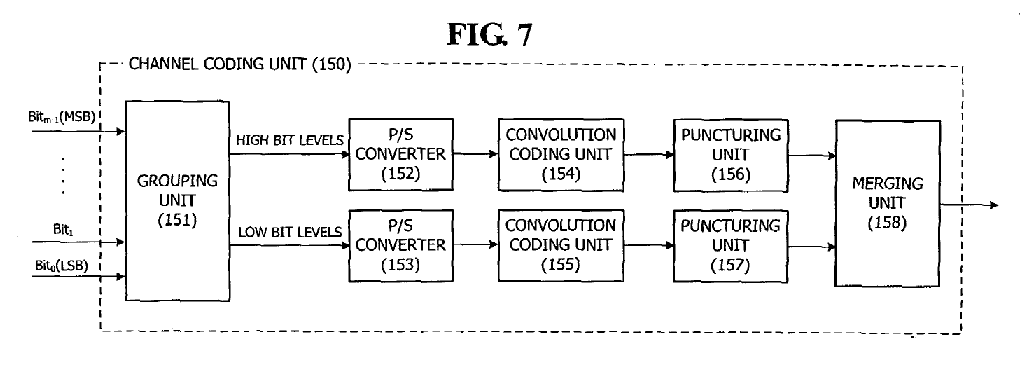

FIG. 7 is a block diagram illustrating the structure of the channel coding unit 150 in more detail. The channel coding unit 150 may be configured to include a grouping unit 151, a plurality of P/S (Parallel/Serial) converters 152 and 153, a plurality of convolution coding units 154 and 155, a plurality of puncturing units 156 and 157, and a merging unit 158.

The grouping unit 151 classifies individual bits having bit levels into a predetermined number of groups. For example, the grouping unit 151 may group 8 bits shown in FIG. 5 into three groups, in the order from the MSB level, in which one of the three groups has two bits and the other groups each have three bits. Those groups become units to which different code rates are applied. Simply, the grouping unit 151 may group the 8 bits into two groups: a group composed of four high-level bits and a group composed of four low-level bits. The grouping method may be variously determined according to attributes of uncompressed AV data to be transmitted, transmission network environments, etc.

For example, when transmission to a large-sized display apparatus is performed, it is possible tp lay emphasis on considerably improved image expression by setting a ratio between a code rate for the high level bit group and a code rate for the low level bit group to 4:4. Meanwhile, when transmitting to a small-sized display apparatus, such as a mobile apparatus, it is possible to focus on development of restoring power of the high level bit group by setting the ratio between the code rate for the high level bit group and the code rate for the low level bit group to, for example, 2:6 or 3:5.

A case in which the grouping unit 151 groups raw data into a group composed of four high-level bits and a group composed of four low-level bits will now be described as an example.

The high-level bits grouped by the grouping unit 151 are input to the P/S converter 152 and the low-level bits are input to the P/S converter 153.

The P/S converter 152 converts parallel data of the four high-level bits into serial data for error correction coding.

The convolution coding unit 154 performs error correction coding on the serial data at a first code rate. Examples of the error correction coding include block coding, convolution coding, etc. In this invention, the convolution coding is used as an example of the error correction coding. The first code rate is lower than a second code rate applied to the four low-level bits. For example, it is possible that the first code rate is set to 1/3 and the second code rate is set to 2/3.

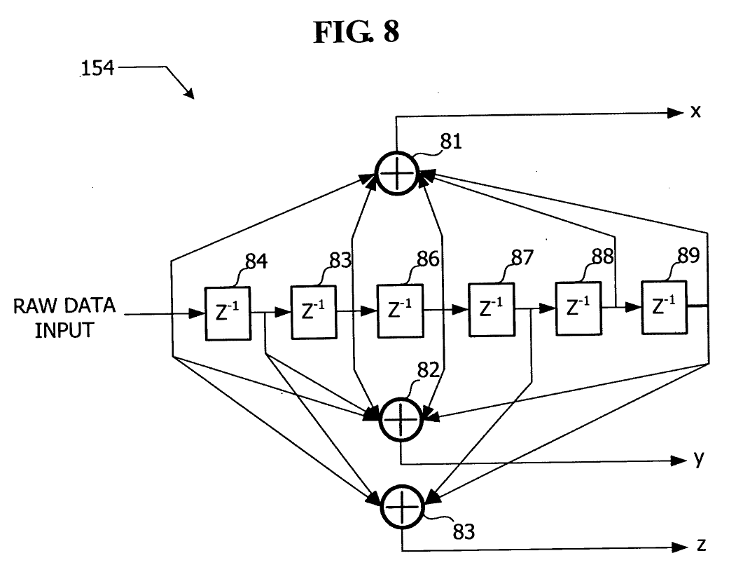

FIG. 8 is a block diagram illustrating the structure of the convolution coding unit 154 having a code rate of 1/3.

The convolution coding unit 154 includes three adders 81, 82, and 83 and six registers 84, 85, 86, 87, 88, and 89. Coefficients of a generating polynomial used here each are 133, 171, and 145. The reason why the convolution coding unit 154 needs a plurality of registers is that a convolution coding algorithm performs coding by comparing previous data with current data. In general, the sum of the number of registers and the number of raw data input, that is, the number of registers plus one is referred to as a constraint length. Consequently, the convolution coding unit 154 receives the raw data and outputs coded data x, y, and z.

The puncturing unit 156 punctures some of the error correction coded data. The puncturing process eliminates some of bits in order to improve the transmission rate of the data coded by the convolution coding unit 154. That is, the puncturing process eliminates some of the bits not to be transmitted. When the puncturing process is performed on the data, the transmittance rate is improved such that a larger amount of data can be transmitted, as compared to when the puncturing process is not performed. However, the possibility of an error occurring during reception increases.

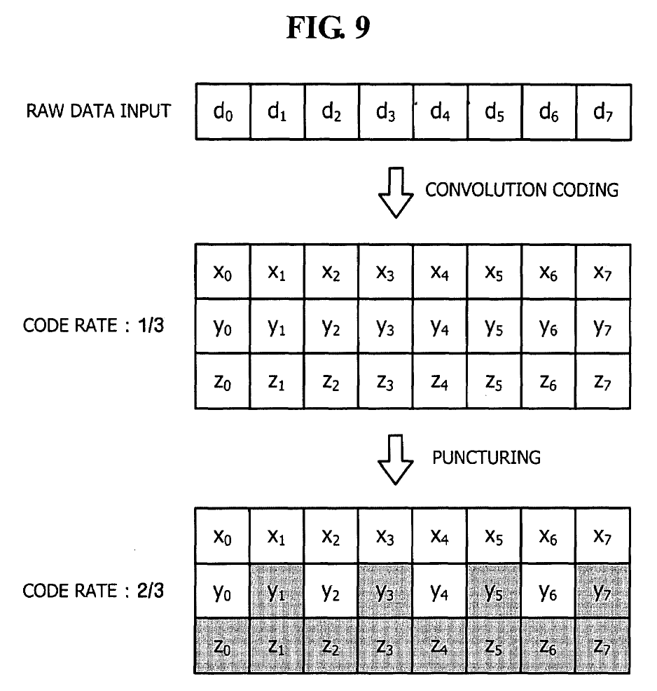

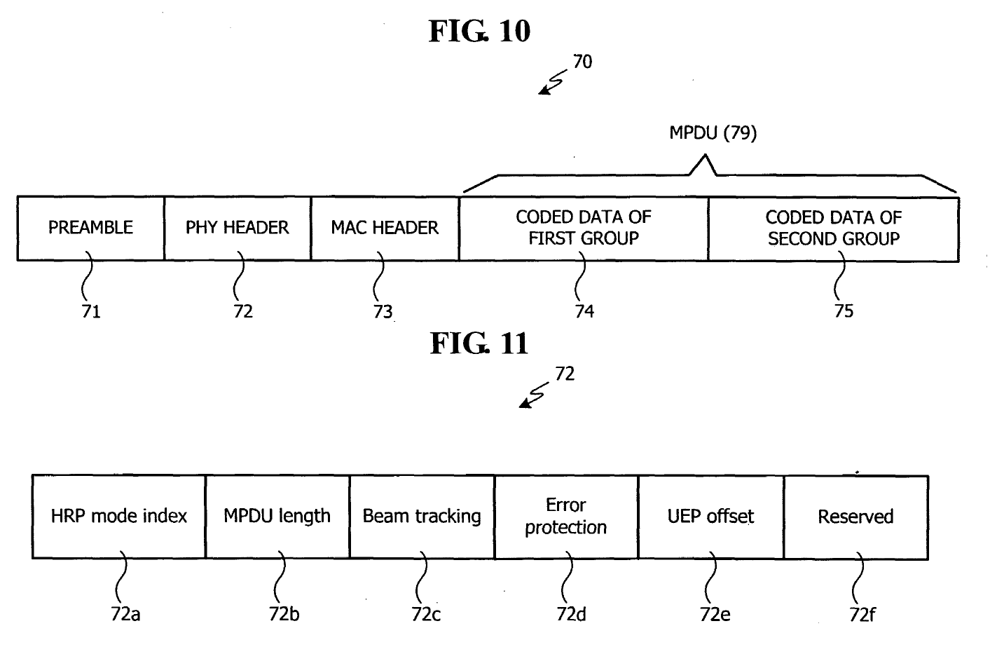

Referring to FIG. 9, by the convolution coding using the code rate of 1/3, the raw data is converted into code words, which are three times as much as the raw data. The puncturing unit 156 periodically performs puncturing to remove some bits of the code words, resulting in conversion of the code rate into of 2/3. Bits shaded in FIG. 9 mean punctured bits. When the first code rate is immediately adjusted by only the convolution coding unit 154, the above-mentioned puncturing process may be omitted.

Table 1 shows free distances and puncturing patterns according to various code rates. In the puncturing patterns, “1” means that a corresponding bit is transmitted, and “0” means that a corresponding bit is removed so as not to be transmitted.

TABLE 1

| Code | | | |
|---|---|---|---|
| rate | Free Distance | Puncturing Pattern | Transmission Order |
| 1/3 | 15 | X: 1 | X1 Y1 Z1 X2 Y2 Z3 |
| | | Y: 1 | |
| | | Z: 1 | |
| 4/7 | 7 | X: 1111 | X1 Y1 X2 X3 Y3 X4 Y4 |
| | | Y: 1011 | |
| | | Z: 0000 | |
| 2/3 | 6 | X: 11 | X1 Y1 X2 X3 X4 |
| | | Y: 10 | |
| | | Z: 00 | |
| 4/5 | 4 | X: 1111 | X1 Y1 X2 X3 X4 |
| | | Y: 1000 | |
| | | Z: 0000 | |

Referring to Table 1, when the code rate is 1/3, “0” does not exist in the puncturing pattern and thus the puncturing process need not be performed. The free distance depends on the code rate. As the free distance increases, the error correcting capability increases. From Table 1, it can be seen that, as the code rate increases, the free distance decreases.

Meanwhile, the low-level bits supplied from the grouping unit 151 are also coded at the second code rate through the P/S converter 153, the convolution coding unit 155, and the puncturing unit 157, similar to the high-level bits.

Finally, the merging unit 158 merges the coded high level bit data (coded data of a first group) and the coded low level bit data (coded data of a second group) so as to generate a payload, that is, a MAC protocol data unit (hereinafter, briefly referred to as MPDU).

The header adding unit 160 adds a MAC header 73, a PHY header 72, and a preamble 71 to an MPDU 79 composed of a plurality of groups 74 and 75 to generate a transmission packet 70 according to an exemplary embodiment of the invention. The preamble 71 is a signal for synchronizing a PHY layer (physical layer) and estimating a channel, and is composed of a plurality of short training signals and a plurality of long training signals.

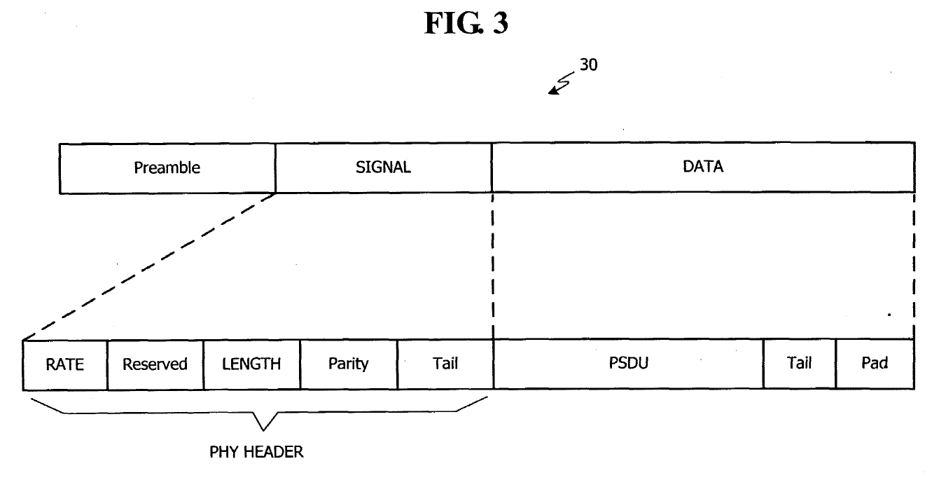

In this exemplary embodiment of the invention, since a transmission rate higher than 3 Gbps is used to transmit uncompressed AV data, the PHY header 72 needs to be different from the PHY header shown in FIG. 3. Therefore, the PHY header 72 is called a high rate PHY (HRP) header.

As shown in FIG. 11, the PHY header 72 includes an HRP mode index field 72a, an MPDU length field 72b, 4 beam tracking field 72, an error protection field 72d, a UEP offset field 72e, and a reserved field 72f.

The HRP mode index field 72a indicates a code rate and a modulating method used for the MPDU 79. In this exemplary embodiment of the invention, the mode index is defined to have any one of values from 0 to 6, as shown in Table 2.

TABLE 2

| | | | Code rate | | Transmission |
|---|---|---|---|---|---|
| | | | High Bit | Low Bit | Rate of Raw |
| HRP Mode | | Modulation | Level | Level | Data |
| Index | Coding Mode | Method | [7][6][5][4] | [3][2][1][0] | (Gb/s) |
| 0 | EEP | QPSK | ⅓ | | 0.97 |
| 1 | | QPSK | ⅔ | | 1.94 |
| 2 | | 16-QAM | ⅔ | | 3.88 |
| 3 | UEP | QPSK | 4/7 | ⅘ | 1.94 |
| 4 | | 16-QAM | 4/7 | ⅘ | 3.88 |
| 5 | Retransmission | QPSK | ⅓ | Infinite | 0.97 |
| 6 | | 16-QAM | ⅓ | Infinite | 1.94 |

Referring to Table 2, it can be seen that an Equal Error Protection (EEP) mode is applied when an HRP mode index is in a range of 0 to 2, and a Unequal Error Protection (UEP) mode is applied when the HRP mode index is 3 or 4. When the HRP mode index is 3, QPSK is applied as a modulation method, and when the HRP mode index is 4, 16-QAM is applied. At this time, a relatively low code rate of 4/7 is applied to the high bit levels, and a relatively high code rate of 4/5 is applied to the low bit levels. However, even in this case, an average code rate for all bit levels is 2/3 and thus the size of data to be transmitted is the same as that when the HRP mode index is 1 or 2.

Meanwhile, the HRP mode indexes 5 and 6 represent the HRP modes that can be used when a transmission error occurs and data is retransmitted. Upon retransmission, a code rate of 1/3 is applied to the high bit levels having relatively high significance, and the low bit levels having relatively low significance are not transmitted (a code rate is infinite).

Referring to FIG. 11 again, the MPDU length field 72b indicates the size of the MPDU 79 in an octet unit.

The beam tracking field 72C is a 1-bit field. When a transmission packet includes beam tracking information, the beam tracking field 72C is represented by 1. When the transmission packet does not include the beam tracking information, the beam tracking field 72C is represented by 0. Since a millimeter wave supporting a transmission rate of several Gbps has high directionality, a directional array antenna may be used for the transmitting apparatus 100. In this case, beam tracking for finding the optimal directionality of the antenna is required, and the transmitting apparatus 100 needs to transmit information on the beam tracking to the receiving apparatus. The beam tracking field 72c indicates whether the information is included.

The error protection field 72d indicates whether EEP or UEP is applied to bits included in the MPDU 79.

The UEP offset field 72e indicates a symbol number where UEP coding is performed, counting from the first symbol after the MAC header 73.

Meanwhile, the MAC header 73 is used for MAC media access control, as in the IEEE 802.11 standard or the IEEE 802.3 standard, and has, for example, MAC addresses of a transmitter and a receiver, an ACK polity, and fragment information recorded thereon.

The RF unit 170 modulates the transmission packet supplied from the header adding unit 160 and transmits the transmission packet through the antenna. For example, the following modulation methods are used: VSB8, VSB16, QPSK, 16-QAM, 32-QAM, and 64-QAM.

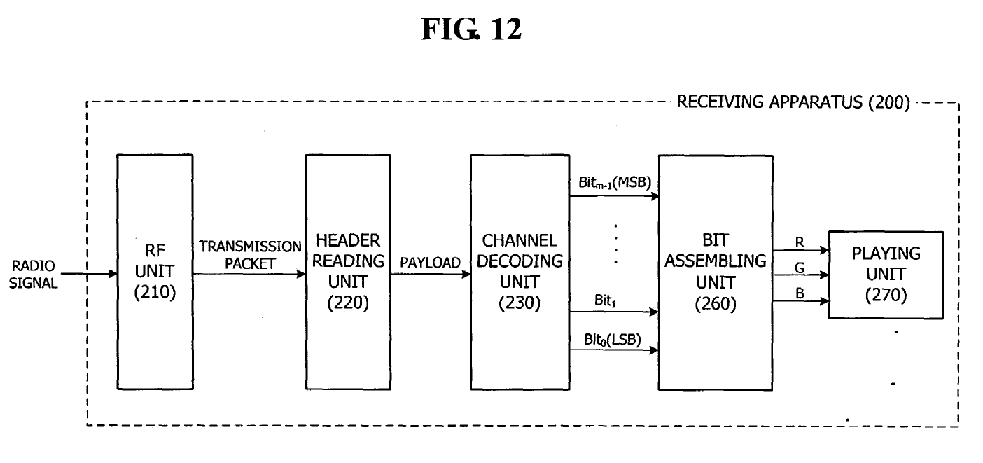

FIG. 12 is a block diagram illustrating the structure of a receiving apparatus 200 for receiving uncompressed AV data according to an exemplary embodiment of the invention. The receiving apparatus 200 includes an RF unit 210, a header reading unit 220, a channel decoding unit 230, a bit assembling unit 260, and a playing unit 270.

The RF unit 210 demodulates a received radio signal to restore a transmission packet. The demodulating process is reverse to the modulating process performed by the RF unit 170 shown in FIG. 6.

The header reading unit 220 reads the PHY header and the MAC header added by the header adding unit 160 shown in FIG. 6 and supplies a payload without the headers to the channel decoding unit 230.

The channel decoding unit 230 performs error correction decoding on data in each of the individual groups 74 and 75, which has coded at different code rates, at the corresponding code rate. The error correction decoding process is reverse to the error correction coding performed by the channel coding unit 150, and includes a process of decoding an n-bit codeword into k-bit original data. The channel decoding unit 230 checks the HRP mode index field 72a of the PHY header 73 so as to acquire the code rates applied to the coded data. Referring to the HRP mode index field 72a, predetermined coding rates for data of the individual groups 74 and 75 can be acquired as shown in Table 2.

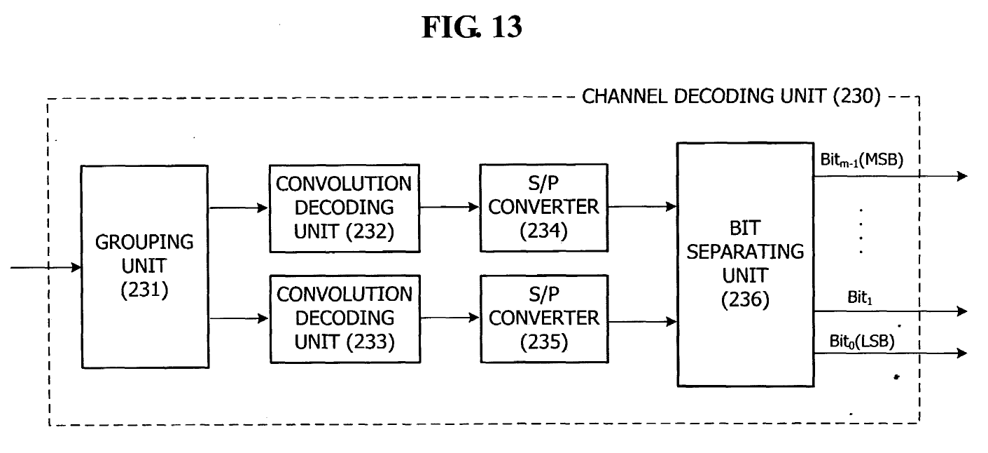

FIG. 13 is a block diagram illustrating the structure of the channel coding unit 230 in more detail. The channel coding unit 230 may be configured to include a grouping unit 231, a plurality of convolution decoding units 232 and 233, a plurality of S/P (Serial/Parallel) converters 234 and 235, and a bit separating unit 236.

The grouping unit 231 groups the payload of the transmission packet into the coded data of the individual groups and supplies the coded data of the individual groups to the plurality of convolution decoding units 232 and 233.

The convolution decoding unit 232 performs convolution decoding on the coded data of the first group paving the relatively high significance at a first code rate. The first code rate is lower than a second code rate applied when the convolution decoding unit 233 performs decoding. The differential coding enables the bits having the relatively high significance to be more likely to be restored than the bits having the relatively low significance. Even though the bits having the relatively low significance fail to be restored, the failure has little effect on the quality of a restored content.

The data decoded by the convolution decoding unit 232 is supplied to the S/P converter 234. The S/P converter 234 converts the decoded serial data into parallel data.

Similarly, the coded data of the second group grouped by the grouping unit 231 also passes through the convolution decoding unit 233 and the S/P converter 235, and is then supplied to the bit separating unit 236.

The bit separating unit 236 temporarily stores the parallel data supplied from the S/P converter 234 and the S/P converter 235 and synchronously outputs individual level bits Bit₀ to Bitₘ₋₁.

Referring to FIG. 12 again, the bit assembling unit 250 assembles the output bits having a plurality of levels (from the highest level to the lowest level) to restore each sub-pixel component. The sub-pixel components (for example, R, G, and B components) restored by the bit assembling unit 250 are supplied to the playing unit 260.

The playing unit 270 collects sub-pixel components, that is, pixel data until one video frame is completed. When one video frame is completed, the playing unit 270 displays the video frame on a display device (not shown), such as a CRT (cathode ray tube), an LCD (liquid crystal display), or a PDP (plasma display panel), in synchronization with a play synchronization signal.

In this exemplary embodiment of the invention, a case in which uncompressed video data is used as the uncompressed AV data is exemplified, but the invention is not limited thereto. For example, it will be understood by those skilled in the art that uncompressed audio data, such as a wave file, can be used as the uncompressed AV data.

The components shown in FIGS. 6, 7, 12 and 13 are realized by software executed in a predetermined area of a memory, such as a task, a class, a sub-routine, a process, an object, an execution thread, or a program, or hardware, such as FPGA (field-programmable gate array) or ASIC (application-specific integrated circuit), or they may be realized by combinations of software and hardware. The components may be stored in a computer readable storage medium, or the components may be dispersed in a plurality of computers.

Although the present invention has been described in connection with the exemplary embodiments of the present invention, it will be apparent to those skilled in the art that various modifications and changes may be made thereto without departing from the scope and spirit of the invention. Therefore, it should be understood that the above exemplary embodiments are not limitative, but illustrative in all aspects.

According to this invention, when uncompressed AV data is transmitted and received, individual error correction coding is applied in consideration of significance of data according to bit position, resulting in high transmission efficiency of the uncompressed AV data.

What is claimed is:

1. A method of transmitting uncompressed audio and/or video (AV) data, the method comprising:
grouping bits of the uncompressed AV data into a plurality of groups according to significance of the bits;
determining code rates for the plurality of groups;
applying error correction coding to the plurality of groups at the determined code rates; and
transmitting the plurality of groups to which the error correction coding has been applied.

2. The method of claim 1, wherein the significance is based on bit levels where the bits are positioned.

3. The method of claim 1, wherein the error correction coding is convolution coding.

4. The method of claim 3, further comprising adjusting the code rates by removing bits of each of the plurality of groups to which the error correction coding has been applied.

5. The method of claim 1, wherein the code rates comprises a first code rate and a second code rate and:
the number of the plurality of groups is two;
the first code rate for a first group of the plurality of groups having higher significance is determined to 4/7; and
the second code rate for a second group of the plurality of groups having lower significance is determined to 4/5.

6. The method of claim 1, further comprising transmitting information representing the determined code rates.

7. A method of receiving uncompressed audio and/or video (AV) data, the method comprising:
receiving uncompressed AV data to which error correction coding has been applied to each one of groups at one of different coding rates;
determining the one of different code rates corresponding to each one of the groups;
applying error correction decoding to each one of the groups at the determined one of different code rates; and
restoring the uncompressed AV data by assembling the groups to which the error correction decoding has been applied.

8. The method of claim 7, wherein the error correction decoding is applied to one of the groups having relatively high significance, at a lower code rate.

9. The method of claim 8, wherein the relatively high significance is based on bit levels where the bits included in the groups are positioned.

10. The method of claim 7, further comprising receiving information representing the different code rates, wherein the determining of the different code rates is performed on the basis of the information.

11. The method of claim 10, wherein the information is included in a physical (PHY) header of the uncompressed AV data to which the error correction coding has been applied.

12. The method of claim 7, wherein the error correction decoding is convolution decoding.

13. The method of claim 7, wherein the restoring of the uncompressed AV data comprises assembling the bits included in the groups to which the error correction decoding has been applied, in the order of bit levels.

14. The method of claim 13, wherein the assembled bits are one of a plurality of sub-pixel values constituting a pixel.

15. An apparatus for transmitting uncompressed audio and/or video (AV) data, the apparatus comprising:
a unit which groups bits of the uncompressed AV data into a plurality of groups according to significance of the bits;
a unit which determines code rates for the groups;
a unit which applies error correction coding to the groups at the determined code rates; and
a unit which transmits the groups to which the error correction coding has been applied.

16. The apparatus of claim 15, wherein the significance is based on bit levels where the bits are positioned.

17. The apparatus of claim 15, wherein the error correction coding is convolution coding.

18. The apparatus of claim 17, further comprising a unit which adjusts the code rates by removing a number of bits of each of the groups to which the error correction coding has been applied.

19. The apparatus of claim 15, wherein the code rates comprises a first code rate and a second code rate and:
the number of groups is two;
the first code rate for a first group of the groups having higher significance is determined to 4/7; and
the second code rate for a second group of the groups having lower significance is determined to 4/5.

20. The apparatus of claim 15, wherein the transmitting unit further transmits information representing the determined code rate.

21. An apparatus for receiving uncompressed audio and/or video (AV) data, the apparatus comprising:
a unit which receives the uncompressed AV data to which error correction coding has been applied to each one of groups at one of different coding rates;
a unit which determines the one of different coding rates corresponding to each one of the groups;
a unit which applies error correction decoding to each one of the groups at the one of the determined code rates; and
a unit which restores the uncompressed AV data by assembling the groups to which the error correction decoding has been applied.

22. The apparatus of claim 21, wherein, the error correction decoding is applied to one of the groups having relatively high significance, at a lower code rate.

23. The apparatus of claim 22, wherein the relatively high significance is based on bit levels where bits included in the one of the groups, are positioned.

24. The apparatus of claim 21, wherein:
the receiving unit further receives information representing the different code rates; and
the determining unit determines the different code rates on the basis of the information.

25. The apparatus of claim 24, wherein the information is included in a physical (PHY) header of the uncompressed AV data to which the error correction coding has been applied.

26. The apparatus of claim 21, wherein the error correction decoding is convolution decoding.

27. The apparatus of claim 21, the restoring unit assembles the bits included in the groups to which the error correction decoding has been applied, in the order of bit levels.

28. The apparatus of claim 27, wherein the assembled bits are one of a plurality of sub-pixel values constituting a pixel.
